(19) United States
(12) Patent Application Publication
(10) Pub. No.: US 2009/0151487 A1
(43) Pub. Date: Jun. 18, 2009

(54) Tilting device

(75) Inventors: Woo-Kun Kim, Saha-gu (KR); Kyoung-Shin Park, Suwon-si (KR); Hyo-Young Kim, Suwon-si (KR); Dong-Won Choi, Suwon-si (KR); Seog-Jin Ma, Suwon-si (KR); Jae-Hun Kim, Suwon-si (KR); Kwang-Hyung Lee, Saha-gu (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/314,856

(22) Filed: Dec. 17, 2008

(30) Foreign Application Priority Data
Dec. 17, 2007 (KR) 10-2007-0131998

(51) Int. Cl. F16H 29/20

(52) U.S. Cl. 74/89.14

(57) ABSTRACT

A tilting device is disclosed. The tilting device may include: a base; a guide, of which one side is hinge-coupled to the base; a jointed link, in which a joint is formed, and of which either end is hinge-coupled respectively to the base and to the other side of the guide, to thereby allow the guide to tilt; a leadscrew engaging the joint; and a driving unit configured to drive the leadscrew. With this configuration, the tilting device may be implemented in a compact structure using a smaller driving unit.

### CROSS-REFERENCE TO RELATED APPLICATIONS

This application claims the benefit of Korean Patent Application No. 10-2007-0131998 filed with the Korean Intellectual Property Office on Dec. 17, 2007, the disclosure of which is incorporated herein by reference in its entirety.

### BACKGROUND

1. Technical Field

The present invention relates to a tilting device.

2. Description of the Related Art

Flat panel displays, such as TV sets and monitors, employing LCD, PDP, LED technology, etc., provide the benefit of allowing efficient use of small spaces, and are fast replacing Braun tube TV's and monitors. The increase in demand for such flat panel displays is expected to continue into the future.

The conventional stand, however, simply affixes the display onto the wall, so that when a user changes one's position, the optimal viewing angle cannot be maintained.

Also, when automatically tilting a mass, e.g. a display, an appropriate power source is required according to the weight of the mass. For a large display, the weight of which can be over 40 kg; a large capacity power source may be required for tilting the display, which can impose additional space limitations and increase cost.

### SUMMARY

An aspect of the invention provides a tilting device, which uses a simple structure to enable a user to obtain a desired tilting angle.

Another aspect of the invention provides a tilting device that includes: a base; a guide, of which one side is hinge-coupled to the base; a jointed link, in which a joint is formed, and of which either end is hinge-coupled respectively to the base and to the other side of the guide, to thereby allow the guide to tilt; a leadscrew engaging the joint; and a driving unit configured to drive the leadscrew.

Here, the jointed link may include a first jointed link and a second jointed link facing each other. A joint in the first jointed link and/or the second jointed link can engage the leadscrew in such a way that causes the first and the second jointed links to move in symmetry.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a rear elevational view illustrating a TV system equipped with a tilting device according to an embodiment of the invention.

FIG. 2 is a perspective view illustrating a tilting device according to an embodiment of the invention.

FIG. 3 is a perspective view illustrating a leadscrew according to an embodiment of the invention.

FIG. 4 is a perspective view illustrating a portion of a tilting device according to an embodiment of the invention.

FIG. 5 is a cross sectional view across line A-A′ in FIG. 2.

FIG. 6 is a cross sectional view across line A-A′ in FIG. 2.

FIG. 7 is a side elevational view illustrating a TV system equipped with a tilting device according to an embodiment of the invention.

### DETAILED DESCRIPTION

The tilting device according to certain embodiments of the invention will be described below in more detail with reference to the accompanying drawings. Those components that are the same or are in correspondence are rendered the same reference numeral regardless of the figure number, and redundant explanations are omitted.

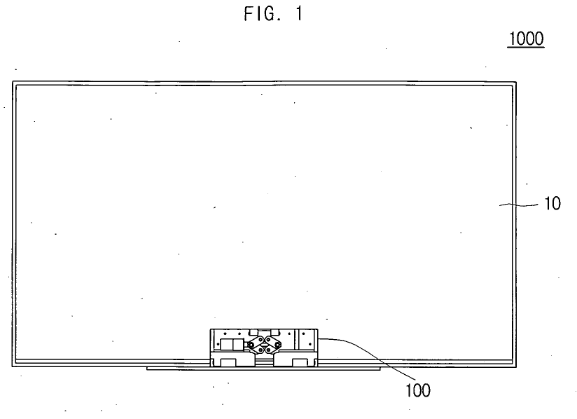

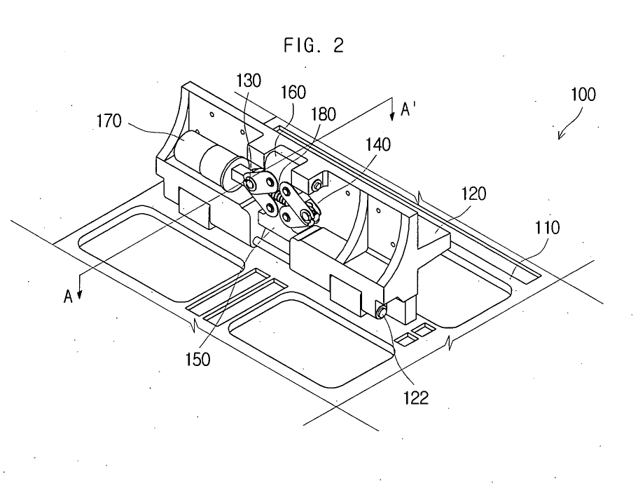

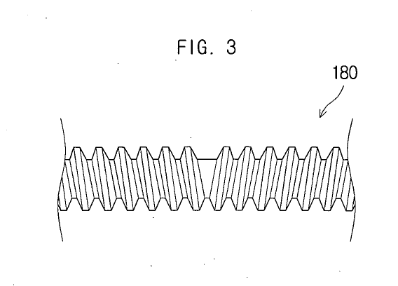

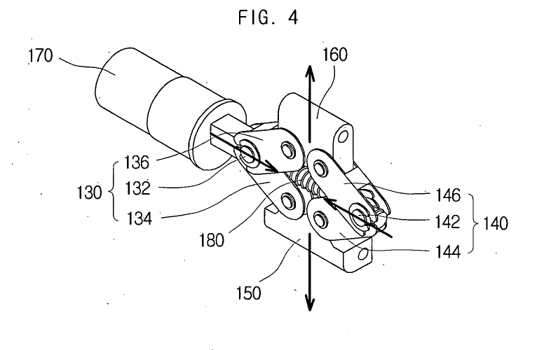

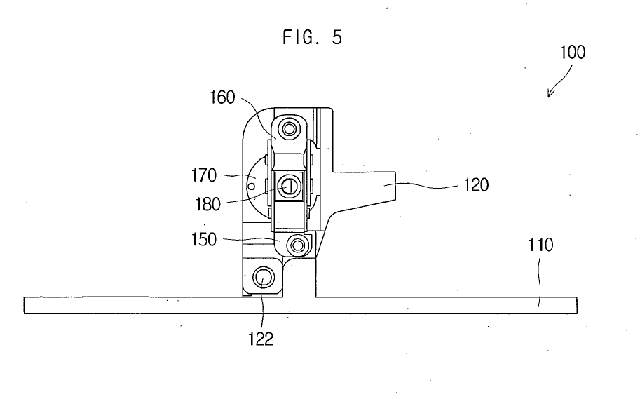

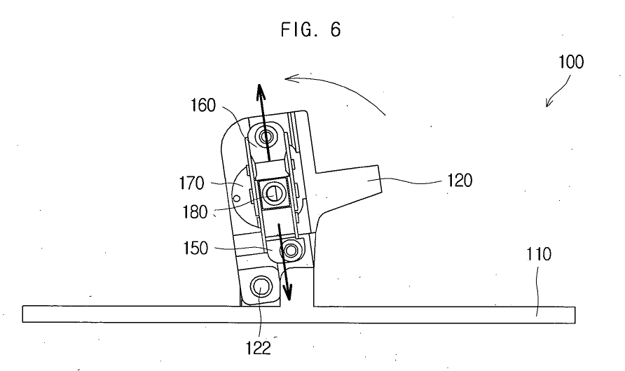

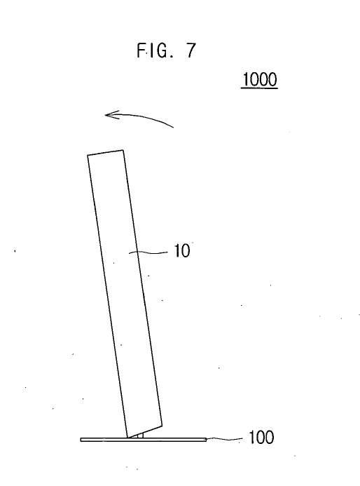

FIG. 1 is a rear elevational view illustrating a TV system equipped with a tilting device according to an embodiment of the invention, FIG. 2 is a perspective view illustrating a tilting device according to an embodiment of the invention, and FIG. 3 is a perspective view illustrating a leadscrew according to an embodiment of the invention. Also, FIG. 4 is a perspective view illustrating a portion of a tilting device according to an embodiment of the invention, and FIGS. 5 and 6 are cross sectional views across line A-A′ in FIG. 2. FIG. 7 is a side elevational view illustrating a TV system equipped with a tilting device according to an embodiment of the invention. In FIGS. 1 to 7, there are illustrated a TV set 10, a tilting device 100, a base 110, a guide 126, a hinge shaft 122, a first jointed link 130, upper lifters 136, 146; lower lifters 134, 144, a motor nut 132, a second jointed link 140, a leadscrew nut 142, a lower stand 150, an upper stand 160, a motor 170, a leadscrew 180, and a TV system 1000.

A tilting device 100 according to this embodiment may include a base 110; a guide 120 having one side hinge-coupled to the base 110; a jointed link, in which a joint is formed, and of which either end may be hinge-coupled respectively to the base 110 and to the other side of the guide 120 to enable tilting for the guide 120; a leadscrew 180 engaging the joint; and a driving unit configured to drive the leadscrew 180. With this embodiment, the tilting device 100 may be implemented in a compact structure using a smaller driving unit.

As in the example illustrated in FIG. 1, the tilting device 100 can be a device coupled with a mass, such as a TV set 10, for example, to adjust the tilting angle.

As in the example illustrated in FIG. 2, the base 110 may form a bottom surface of the tilting device 100 and may support the TV set 10. The guide 120 may have one side hinge-coupled to the base 110. The base 110 may be coupled in such a manner that allows the base 110 to rotate about the hinge shaft 122. The guide 120 may also be coupled with the bottom of the TV set 10 to support the TV set 10.

Either end of a jointed link 130, 140 may be coupled with the other side of the guide 120 and with the base 110, respectively, to allow the guide 120 to undergo tilting motions. A joint may be formed in each jointed link 130, 140. Here, the jointed link can include a first and second jointed link 130, 140 facing each other. The first jointed link 130 can include an upper lifter 136, a lower lifter 134, and a motor nut 132, which is a joint that rotatably connects the lower and upper lifters 134, 136.

The second jointed link 140 can include an upper lifter 146, a lower lifter 144, and a leadscrew nut 142, which is a joint that rotatably connects the lower and upper lifters 144, 146. A joint is a portion that can rotatably connect each of the arms that form the jointed link, and in this particular embodiment, the joint can be the motor nut 132 or the leadscrew nut 142. The first and second jointed links 130, 140 can each have either end hinge-coupled, by way of an upper stand 160 and a lower stand 150, respectively, with the other side of the guide 120 and with the base 110.

The leadscrew 180 may engage the joints, where the joints of the first and second jointed links 130, 140 can be meshed with the leadscrew 180 to move in symmetry to each other. As in the example illustrated in FIG. 3, the threads of the leadscrew 180 can be formed symmetrically about the middle. By transferring the driving power using the leadscrew 180, a large gear reduction ratio may be obtained, so that the tilting device may be implemented with a smaller drive source. Also, by using the leadscrew, a particular tilting angle can be maintained without the need for a separate stopper.

As in the example illustrated in FIG. 4, with the motor nut 132 and leadscrew nut 142 meshed with the leadscrew 180, the motor nut 132 and the leadscrew nut 142 can be made to move symmetrically, even when the leadscrew 180 rotates in one direction. That is, when a motor 170, which is an example of a driving unit for driving the leadscrew 180, rotates in one direction, the leadscrew nut 142 and the motor nut 132 can each move right and left, at which the jointed link structure can cause the upper stand 160 and lower stand 150 to separate up and down.

As in the example illustrated in FIG. 5, one side of the guide 120 may be hinge-coupled to the base 110, while the other side of the guide 120 may be hinge-coupled to the upper stand 160. Also, the lower stand 150 may be hinge-coupled to the base 110. As in the example illustrated in FIG. 6, when the motor 170 rotates the leadscrew 180, the driving power may be transferred through the first and second jointed links 130, 140 to separate the upper stand 160 and lower stand 150 up and down, allowing the guide 120 to tilt about the hinge shaft 122. As in the example illustrated in FIG. 7, a tilting device according to this embodiment may, using the leadscrew 180 and jointed link structure, allow tilting for a heavy object, such as a TV set 10, etc., with a small driving source. Thus, a user may watch TV from a desired position.

According to certain aspects of the invention as set forth above, a tilting device may be implemented in a compact structure using a smaller driving unit.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention. As such, many embodiments other than those set forth above can be found in the appended claims.

What is claimed is:

1. A tilting device comprising:
a base;
a guide having one side thereof hinge-coupled to the base;
a jointed link having either end thereof hinge-coupled respectively to the base and the other side of the guide such that the guide is able to tilt, the jointed link having a joint formed therein;
a leadscrew engaging the joint; and
a driving unit configured to drive the leadscrew.

2. The tilting device of claim 1, wherein the jointed link comprises a first jointed link and a second jointed link facing each other.

3. The tilting device of claim 2, wherein a joint of the first and the second jointed links engages the leadscrew such that the first and the second jointed links move in symmetry.
